(19) United States
(12) Patent Application Publication
(10) Pub. No.: US 2014/0092584 A1
(43) Pub. Date: Apr. 3, 2014

(54) LIGHT-EMITTING DEVICE, ILLUMINATING APPARATUS, AND DISPLAY APPARATUS

(71) Applicants: Yasuhiro Ono, Osaka-shi (JP); Makoto Masuda, Osaka-shi (JP); Kenzo Ohkubo, Osaka-shi (JP); Nobuhiro Shirai, Osaka-shi (JP); Takasumi Wada, Osaka-shi (JP)

(72) Inventors: Yasuhiro Ono, Osaka-shi (JP); Makoto Masuda, Osaka-shi (JP); Kenzo Ohkubo, Osaka-shi (JP); Nobuhiro Shirai, Osaka-shi (JP); Takasumi Wada, Osaka-shi (JP)

(73) Assignee: SHARP KABUSHIKI KAISHA, Osaka-shi, Osaka (JP)

(21) Appl. No.: 14/006,894

(22) PCT Filed: Feb. 27, 2012
(86) PCT No.: PCT/JP2012/054790

§ 371 Date: Nov. 26, 2013

(30) Foreign Application Priority Data
Mar. 25, 2011 (JP) 2011-066839
Aug. 25, 2011 (JP) 2011-184175

(51) Int. Cl. F21K 99/00

(52) U.S. Cl. CPC F21K 9/50
USPC 362/97.1; 362/296.01; 362/235

(57) ABSTRACT

The invention provides a light-emitting device a light-emitting device for use in a backlight unit of a display apparatus including a display panel, which is capable of applying light to an illumination object with uniformity in brightness in a planar direction of the illumination object and can be made lower in profile. A backlight unit (1) is provided with: a printed circuit board (12); a plurality of light-emitting portions (111) disposed on the printed circuit board (12) and having a base support (111b), an LED chip (111a) and a lens (112); and a first reflective member (118) disposed on a periphery of each light-emitting portion (111) and having a first reflecting portion (1181) and a second reflecting portion (1182).

### TECHNICAL FIELD

The present invention relates to a light-emitting device which is disposed in a backlight unit for applying light to a display panel from a back side, and an illuminating apparatus and a display apparatus including the light-emitting device.

### BACKGROUND ART

In a display panel in which a liquid crystal is sealed in between two transparent substrates, upon application of voltage, the orientations of liquid crystal molecules are changed with consequent variations in light transmittance, so that a predetermined image or the like is displayed in an optical manner. In the display panel, since the liquid crystal does not emit light by itself as a light emitter, for example, a transmissive display panel has, at its back side, a backlight unit for effecting irradiation of light from a light source such as a cold-cathode tube (CCFL) or a light-emitting diode (LED).

Backlight units are classified into two categories, namely a direct-lighting type in which light sources such as cold-cathode tubes or LEDs are arranged at the bottom for light emission, and an edge-lighting type in which light sources such as cold-cathode tubes or LEDs are arranged at an edge portion of a transparent plate called a light guide plate, so that light is directed forward, through printed dots or patterns formed at the back, from the edge of the light guide plate.

Although the LED has excellent characteristics, including lower power consumption, longer service life, and the capability of reduction in environmental burdens without the use of mercury, its use as a light source for a backlight unit has fallen behind because of its expensiveness, the fact that there had been no white-color LED prior to the invention of a blue-color LED, and its high directivity. However, in recent years, as white-color LEDs exhibiting high color rendition and high brightness spring into wide use for illumination application purposes, LEDs are becoming less expensive, and consequently, as a light source for a backlight unit, the shift from the cold-cathode tube to the LED has picked up momentum.

LEDs have high directivity, wherefore a backlight unit of edge-lighting type has the advantage over a backlight unit of direct-lighting type from the standpoint of effecting light irradiation in a manner such that a display panel exhibits uniform surface brightness in a planar direction thereof. However, the edge-lighting type backlight unit poses the following problems: localized arrangement of light sources at the edge portion of the light guide plate results in concentration of heat generated by the light sources; and the size of the bezel portion of the display panel is inevitably increased. Furthermore, the edge-lighting type backlight unit is subjected to severe restrictions in terms of local dimming control which attracts attention as a control technique capable of display of high-quality images and energy saving, and is therefore incapable of split-region control that achieves production of high-quality displayed images and low power consumption as well.

In view of the foregoing, studies are going on to come up with a method whereby, even if a highly-directive LED is used as a light source in a direct-lighting type backlight unit having an advantage in its suitability for local dimming control, a display panel can be irradiated with light with uniformity in brightness.

For example, in Patent Literature 1, there is disclosed an inverted cone-shaped light-emitting lamp composed of a light-emitting element, a resin lens having an inverted cone-shaped recess disposed so as to cover the light-emitting element, and a reflective plate disposed to be inclined around the resin lens. Moreover, in Patent Literature 2, there is disclosed a light-emitting diode composed of a light-emitting element and a light-transmittable material disposed so as to cover the light-emitting element, for allowing incident light to diffuse in a lateral direction. Moreover, in Patent Literature 3, there is disclosed a side-lighting-type LED package composed of a light-emitting element and a transparent resin-made molding portion having a centrally-recessed, conically-curved surface disposed so as to cover the light-emitting element. Furthermore, in Patent Literature 4, there is disclosed a light-source unit composed of a light-emitting element, a light guide reflector for guiding light emitted from the light-emitting element while reflecting the light in a direction orthogonal to an optical axis, and a reflective member which surrounds the light-emitting element and extends perpendicularly with respect to an illumination object. In addition, in Patent Literature 5, there is disclosed an illuminating apparatus composed of a light-emitting element and a substantially arc-like reflective plate which surrounds the light-emitting element.

### CITATION LIST

### Patent Literature

Patent Literature 1: Japanese Unexamined Patent Publication JP-A 61-127186 (1986)
Patent Literature 2: Japanese Unexamined Patent Publication JP-A 2003-158302
Patent Literature 3: Japanese Unexamined Patent Publication JP-A 2006-339650
Patent Literature 4: Japanese Unexamined Patent Publication JP-A 2010-238420
Patent Literature 5: U.S. Pat. No. 7,172,325 B2

### SUMMARY OF INVENTION

### Technical Problem

According to the technologies as disclosed in Patent Literatures 1 to 5, light having high directional property emitted from a light-emitting element is diffused in a direction intersected by the optical axis of the light-emitting element, so that a display panel can be irradiated with the light in its planar direction.

In keeping with the recent increasing demand for a display apparatus of even lower profile, a light-emitting device of direct-lighting type that is to be mounted in such a slimmed-down display apparatus is required to have the capability of allowing light emitted from a light-emitting element to diffuse in a direction intersected by the optical axis of the light-emitting element with high accuracy. However, the technologies as disclosed in Patent Literatures 1 to 5 cannot fully satisfy the above requirement.

For example, in the device disclosed in Patent Literature 1, light emitted from the light-emitting element is applied to the inclined reflective plate by the resin lens, and is then reflected from the reflective plate so as to travel toward an illumination object. Therefore, in this device, reflection of light does not occur in a region between the reflective plate and the resin lens, in consequence whereof there results reduction in the quantity of light applied to a part of the illumination object which faces that region.

Moreover, for example, the device disclosed in Patent Literature 2 is a LED light including a light-emitting diode, and, as shown in FIG. 2 of Patent Literature 2, the light-emitting region thereof is given a circular shape, which leads to unsuitability for local dimming.

Moreover, for example, the device disclosed in Patent Literature 3 comprises the side-lighting-type LED package, wherefore light is hardly applied to a part of an illumination object which faces the light-emitting element, in consequence whereof there results reduction in the quantity of light applied to this part.

Furthermore, for example, in the device disclosed in Patent Literature 4, since the reflective member extends perpendicularly with respect to the illumination object, it follows that light emitted horizontally from the light-emitting element is reflected from the reflective member so as to return to the light-emitting element, wherefore the quantity of light at the upper part of the reflective member becomes small, which gives rise to lack of uniformity in irradiated light in the planar direction of the illumination object.

In addition, for example, in the device disclosed in Patent Literature 5, the reflective plate is given a substantially arc-like shape to apply light emitted from the light-emitting element uniformly to an illumination object, and also the angle of incidence of light emitted from the light-emitting element is adjusted. Therefore, if the reflective plate has a small thickness dimension, adjustment to the angle of incidence will become difficult, and consequently the size of the device disclosed in patent literature 5 will be increased, which makes it difficult to achieve both a downsizing of the device and attainment of uniformity in the quantity of irradiated light.

Accordingly, an object of the invention is to provide a light-emitting device for use in a backlight unit of a display apparatus including a display panel, which is capable of applying light to an illumination object with uniformity in brightness in the planar direction of the illumination object and can be made lower in profile, as well as to provide an illuminating apparatus and a display apparatus including the light-emitting device.

### Solution to Problem

The invention provides a light-emitting device for applying light to an illumination object, comprising:

a light-emitting portion that emits light; and

a reflective member that reflects light emitted from the light-emitting portion, the reflective member comprising a base portion which is disposed around the light-emitting portion in a position farther away than the light-emitting portion with respect to the illumination object in an optical-axis direction of the light-emitting portion and extends in a flat form in a direction perpendicular to an optical axis of the light-emitting portion, and

an inclined portion surrounding the light-emitting portion to be inclined with respect to the base portion, a surface of the inclined portion facing the light-emitting portion extending in a flat form,

the light-emitting portion being configured to emit light toward at least the base portion, and including a light-emitting element, a base support which supports the light-emitting element, and an optical member which is disposed so as to cover the light-emitting element and refract light emitted from the light-emitting element in a plurality of directions,

the reflective member being so disposed that light emitted from a side surface of the optical member is reflected from the base portion, part of the light reflected from the base portion is applied to the illumination object, and another part of the light reflected from the base portion is further reflected from the inclined portion so as to be applied to the illumination object.

In the invention, it is preferable that the optical member is disposed in contact with the base support.

Moreover, in the invention, it is preferable that an area of the base portion projected on the illumination object is greater than an area of the inclined portion projected on the illumination object.

Moreover, in the invention, it is preferable that a distance in the optical-axis direction between a part of the inclined portion which lies farthest from a surface of the base portion in the optical-axis direction and the surface of the base portion is shorter than a distance in the optical-axis direction between a part of the optical member which lies farthest from the surface of the base portion in the optical-axis direction and the surface of the base portion.

The invention provides an illuminating apparatus comprising:

a plurality of the light-emitting devices being arranged in an orderly manner.

Moreover, in the invention, it is preferable that a plurality of the reflective members provided in the light-emitting devices are integrally formed at inclined portions thereof so that the reflective members are continuous with respective adjacent ones.

The invention provides a display apparatus comprising:

a display panel; and

an illuminating apparatus including the light-emitting device or the above-described illuminating apparatus, the illuminating apparatus applying light to a back side of the display panel.

### Advantageous Effects of Invention

According to the invention, light emitted from the light-emitting portion, at least partly, reaches the base portion of the reflective member disposed around the light-emitting portion. Part of the light which has reached the base portion is reflected from the flat-shaped base portion so as to be applied to the illumination object. Since the light reflected from the base portion travels diffusely, it is possible to apply a sufficient quantity of light not only to that region of the illumination object which faces the light-emitting portion, but also to vicinal regions thereof.

Moreover, the other part of the light which has reached the base portion is reflected from the base portion for its travel toward the inclined portion, and is then reflected from the flat-shaped inclined portion so as to be applied to the illumination object. Accordingly, even if the inclined portion is not given a substantially arc-like shape, in the illumination object, not only the regions facing the light-emitting portion and the base portion, but also a vicinal region facing the inclined portion can be irradiated with a sufficient quantity of light. This makes it possible to apply light to the illumination object with uniformity in brightness in the planar direction, as well as to make the illuminating apparatus lower in profile. That is, according to the invention, by the reflecting action of the flat base portion, light emitted from the light-emitting portion is able to travel as far away from the light-emitting portion as possible in the planar direction, and, in a distant place where the light reaches, reflection is caused by the flat inclined portion, whereby light can be supplied to that region of the illumination object which lies far away from the light-emitting portion where the brightness tends to be low. In consequence, even in the low-profile illuminating apparatus, a sufficient level of uniformity in brightness can be ensured in the planar direction.

Moreover, since the reflective member is so disposed that light emitted from a side surface of the optical member is reflected from the base portion, that part of the light reflected from the base portion is applied to the illumination object, and that the other part of the light reflected from the base portion is further reflected from the inclined portion so as to be applied to the illumination object, it is possible to apply light to the illumination object with uniformity in brightness in the planar direction of the illumination object.

Moreover, according to the invention, since the optical member is disposed in contact with the base support that supports the light-emitting element, it is possible to refract light emitted from the light-emitting element with high accuracy, and thereby apply light to the illumination object with uniformity in brightness in the planar direction of the illumination object.

Moreover, according to the invention, the area of the base portion projected on the illumination object is greater than the area of the inclined portion projected on the illumination object. The larger the projected area of the base portion is, the larger the area of irradiation of light emitted from the optical member on the base portion is, wherefore the quantity of light applied to the illumination object by the reflecting action of the base portion is increased, and the quantity of light applied to the inclined portion by the reflecting action of the base portion is also increased, and consequently, the quantity of light around the reflective member can be increased for attainment of a higher level of uniformity in brightness in the planar direction of the illumination object.

Moreover, according to the invention, since the distance in the optical-axis direction between the part of the inclined portion which lies farthest from the surface of the base portion in the optical-axis direction and the surface of the base portion is shorter than the distance in the optical-axis direction between the part of the optical member which lies farthest from the surface of the base portion in the optical-axis direction and the surface of the base portion, it is possible to suppress a decrease in the quantity of light applied to the illumination object in a region between the light-emitting portions, and thereby attain a higher level of uniformity in brightness in the planar direction of the illumination object.

Moreover, according to the invention, the illuminating apparatus can be constructed by providing a plurality of the light-emitting devices and arranging them in an orderly manner.

Moreover, according to the invention, since a plurality of the reflective members are integrally molded, it is possible to improve the accuracy of placement positions of the light-emitting portions relative to their respective reflective members, and thereby allow the reflective member to reflect light in a manner such that a higher level of uniformity in brightness can be ensured in the illumination object in its planar direction.

Moreover, according to the invention, in the display apparatus, light is applied to the back side of the display panel by the illuminating apparatus including the light-emitting devices, wherefore images of even higher quality can be shown on the display panel.

### BRIEF DESCRIPTION OF DRAWINGS

Other and further objects, features, and advantages of the invention will be more explicit from the following detailed description taken with reference to the drawings wherein:

FIG. 1 is an exploded perspective view showing the structure of a liquid-crystal display apparatus 100 in accordance with a first embodiment of the invention;

FIG. 2A is a view schematically showing the section of the liquid-crystal display apparatus 100 taken along the line A-A of FIG. 1;

FIG. 2B is a view showing a state where a plurality of light-emitting devices 11 are arranged in an orderly manner;

FIG. 3A is a view showing the positional relationship between an LED chip 111a supported by a base support 111b and the lens 112;

FIG. 3B is a view showing the base support 111b and the LED chip 111a;

FIG. 3C is a view showing the base support 111b and the LED chip 111a;

FIG. 3D is a view showing the base support 111b and the LED chip 111a;

FIG. 3E is a view showing the LED chip 111a and the base support 111b mounted on the printed circuit board 12;

FIG. 4 is a view for explaining an optical path of light emitted from the LED chip 111a;

FIG. 5 is a perspective view of a first reflective member 118 and a light-emitting portion 111;

FIG. 6 is a perspective view of the first reflective member 118;

FIG. 7A is a view schematically showing the section of the liquid-crystal display apparatus 100 in accordance with a second embodiment taken along the line A-A of FIG. 1;

FIG. 7B is a view schematically showing the section of the liquid-crystal display apparatus 100 in accordance with the second embodiment taken along the line B-B of FIG. 1;

FIG. 8 is a perspective view of a reflective member 113;

FIG. 9 is a view showing the reflective member 113 as viewed in a plan view in the direction X;

FIG. 10 is a view showing how the adjacent light-emitting portions 111 complement each other in respect of the insufficiency of light quantity;

FIG. 11A is a view showing the reflective member 113 having a second reflecting member 1132, and a lens 112;

FIG. 11B is a view showing an example of a light quantity adjustment member;

FIG. 11C is a view showing the light-emitting device 11 provided with the second reflecting member 1132 and the light quantity adjustment member;

FIG. 12 is a perspective view of a first reflecting member 115 and a reflecting sheet 116;

FIG. 13 is a view showing the first reflecting member 115 as viewed in a plan view in the direction X;

FIG. 14 is a view showing a reflecting sheet 116 as viewed in a plan view in the direction X;

FIG. 15 is an exploded perspective view of the reflective member 113;

FIG. 16 is a view showing a reflective member including a third reflecting member 117; and

FIG. 17 is a view showing an optical path of light emitted from the light-emitting portion 111.

### DESCRIPTION OF EMBODIMENTS

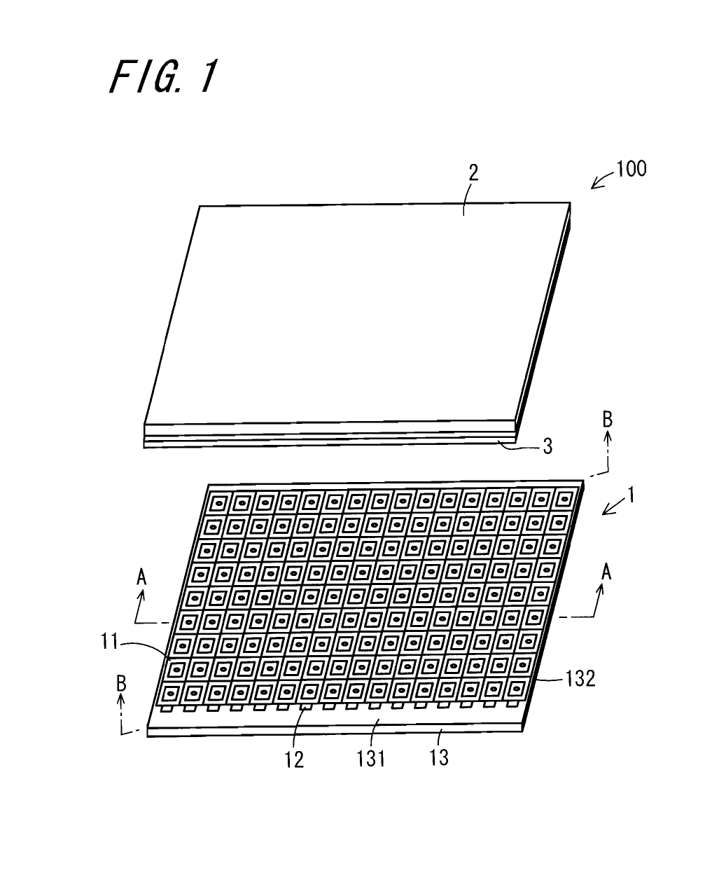

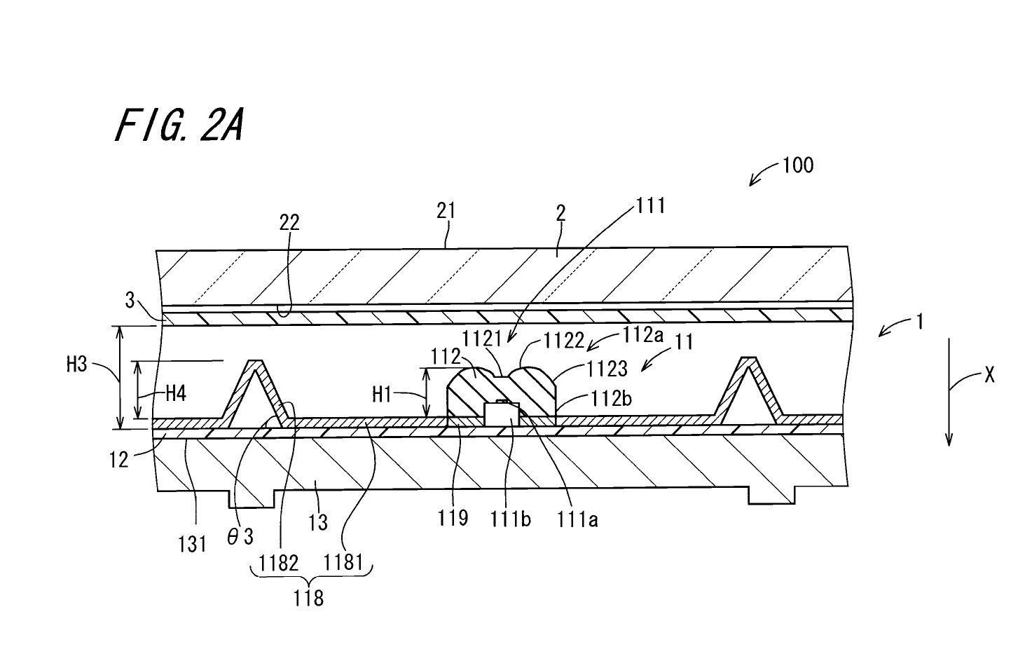

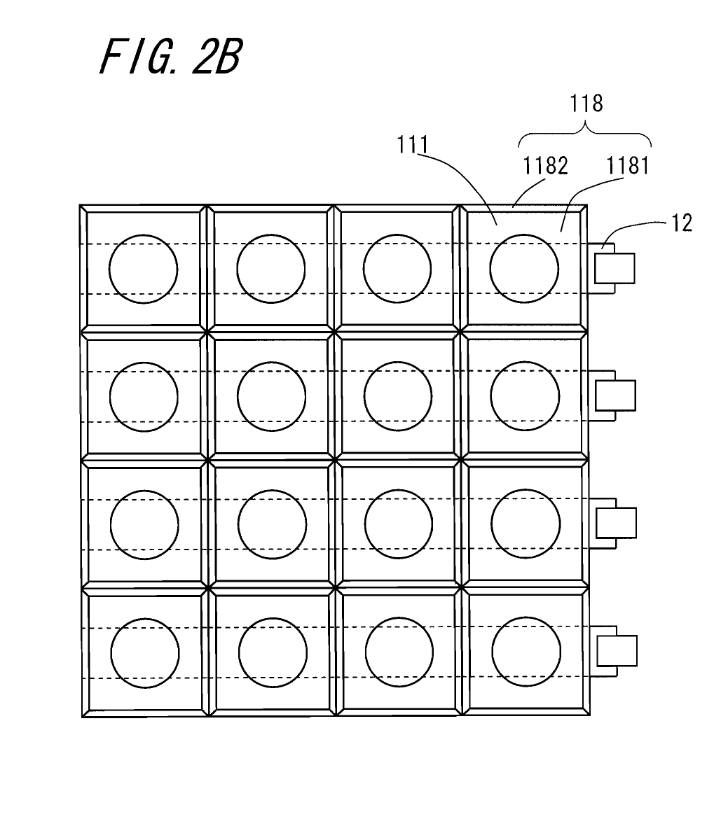

FIG. 1 is an exploded perspective view showing the structure of a liquid-crystal display apparatus 100 in accordance with a first embodiment of the invention. FIG. 2A is a view schematically showing the section of the liquid-crystal display apparatus 100 taken along the line A-A of FIG. 1. The liquid-crystal display apparatus 100 which is a display apparatus according to the invention is designed for use in television sets, personal computers, and so forth, for showing an image on a display screen in response to output of image information. The display screen is constructed of a liquid-crystal panel 2 which is a transmissive display panel having liquid-crystal elements, and the liquid-crystal panel 2 has the form of a rectangular flat plate. In the liquid-crystal panel 2, two sides in a thickness-wise direction thereof will be referred to as a front 21 side and a back 22 side, respectively. The liquid-crystal display apparatus 100 shows an image in a manner such that the image is viewable from the front 21 side.

The liquid-crystal display apparatus 100 comprises the liquid-crystal panel 2 and a backlight unit 1 which is an illuminating apparatus including a light-emitting device according to the invention. The liquid-crystal panel 2 is supported on a sidewall portion 132 in parallel relation to a bottom portion 131 of a frame member 13 provided in the backlight unit 1. The liquid-crystal panel 2 includes two substrates, and is shaped like a rectangular plate when viewed in the thickness-wise direction. The liquid-crystal panel 2 includes a switching element such as a TFT (thin film transistor), and a liquid crystal is filled in a gap between the two substrates. The liquid-crystal panel 2 performs display function through irradiation of light from the backlight unit 1 placed at the back 22 side as backlight. The two substrates are provided with a driver (source driver) used for pixel driving control in the liquid-crystal panel 2, and various elements and wiring lines.

Moreover, in the liquid-crystal display apparatus 100, a diffusion plate 3 is disposed between the liquid-crystal panel 2 and the backlight unit 1 in parallel relation to the liquid-crystal panel 2. A prism sheet may be interposed between the liquid-crystal panel 2 and the diffusion plate 3.

The diffusion plate 3 diffuses light emitted from the backlight unit 1 in the planar direction thereof to prevent localized brightness variations. The prism sheet controls the traveling direction of light that has reached there from the back 22 side through the diffusion plate 3 so that the light is directed toward the front 21 side. In the diffusion plate 3, to prevent lack of uniformity in brightness in the planar direction, the traveling direction of light involves, as vector components, many planar-directional components. On the other hand, in the prism sheet, the traveling direction of light involving many planar-directional vector components is converted into a traveling direction of light involving many thickness-directional components. Specifically, the prism sheet is formed by arranging a large number of lenses or prismatic portions in the planar direction, and this arrangement allows reduction in the degree of diffusion of light traveling in the thickness-wise direction. This makes it possible to enhance the brightness of the display in the liquid-crystal display apparatus 100.

The backlight unit 1 is a backlight device of direct-lighting type for applying light to the liquid-crystal panel 2 from the back 22 side. The backlight unit 1 includes a plurality of light-emitting devices 11 for applying light to the liquid-crystal panel 2, a plurality of printed circuit boards 12, and the frame member 13.

The frame member 13 serves as a basic structure of the backlight unit 1, and is composed of the flat plate-shaped bottom portion 131 opposed to the liquid-crystal panel 2, with a predetermined spacing secured between them, and the sidewall portion 132 which is continuous with the bottom portion 131 so as to extend upright therefrom. The bottom portion 131 is rectangular-shaped when viewed in the thickness-wise direction, and its size is slightly larger than the size of the liquid-crystal panel 2. The sidewall portion 132 is formed so as to extend upright toward the front 21 side of the liquid-crystal panel 2 from each of two edges corresponding to the short sides of the bottom portion 131 and another two edges corresponding to the long sides thereof. That is, four flat plate-shaped sidewall portions 132 are formed along the periphery of the bottom portion 131.

The printed circuit board 12 is fixed to the bottom portion 131 of the frame member 13. On the printed circuit board 12 are arranged a plurality of light-emitting devices 11. The printed circuit board 12 is, for example, a glass epoxy-made substrate having an electrically-conductive layer formed on each side.

The plurality of light-emitting devices 11 are intended to apply light to the liquid-crystal panel 2. In this embodiment, the plurality of light-emitting devices 11 are arranged in a group, and, a plurality of printed circuit boards 12 each having the plurality of light-emitting devices 11 are juxtaposed so as to face the entire area of the back 22 of the liquid-crystal panel 2, with the diffusion plate 3 lying between them, thereby providing matrix arrangement of the light-emitting devices 11. That is, as shown in FIG. 2B which is an enlarged view of part of FIG. 1, the plurality of light-emitting devices 11 are arranged in an orderly manner. While, in this embodiment, the plurality of light-emitting devices 11 are arranged in a matrix, their arrangement is not so limited. Each of the light-emitting devices 11, which is square-shaped when viewed in a plan view in a direction X perpendicular to the bottom portion 131 of the frame member 13, is designed so that the light quantity level stands at 6000 cd/m², and the length of a side of the square shape is set at 55 mm, for example.

Each of the plurality of light-emitting devices 11 comprises a light-emitting portion 111 and a first reflective member 118 placed around the light-emitting portion 111 on the printed circuit board 12. The light-emitting portion 111 includes a light-emitting diode (LED) chip 111a which is a light-emitting element, a base support 111b for supporting the LED chip 111a, and a lens 112 which is an optical member.

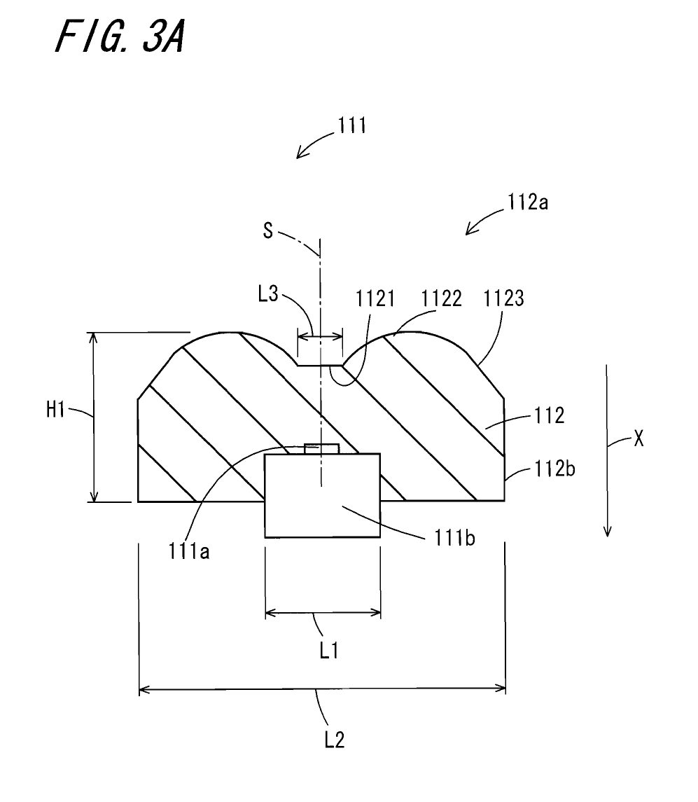

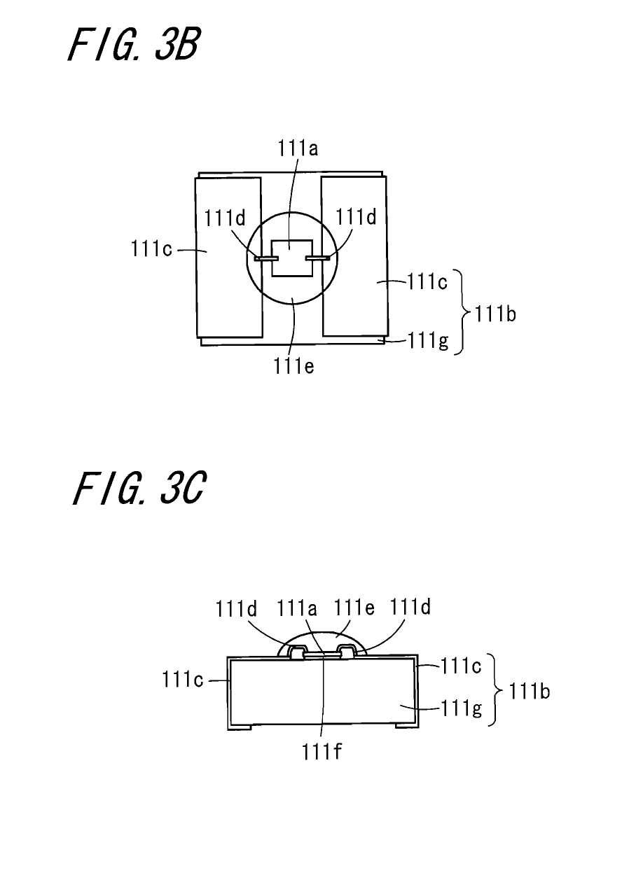

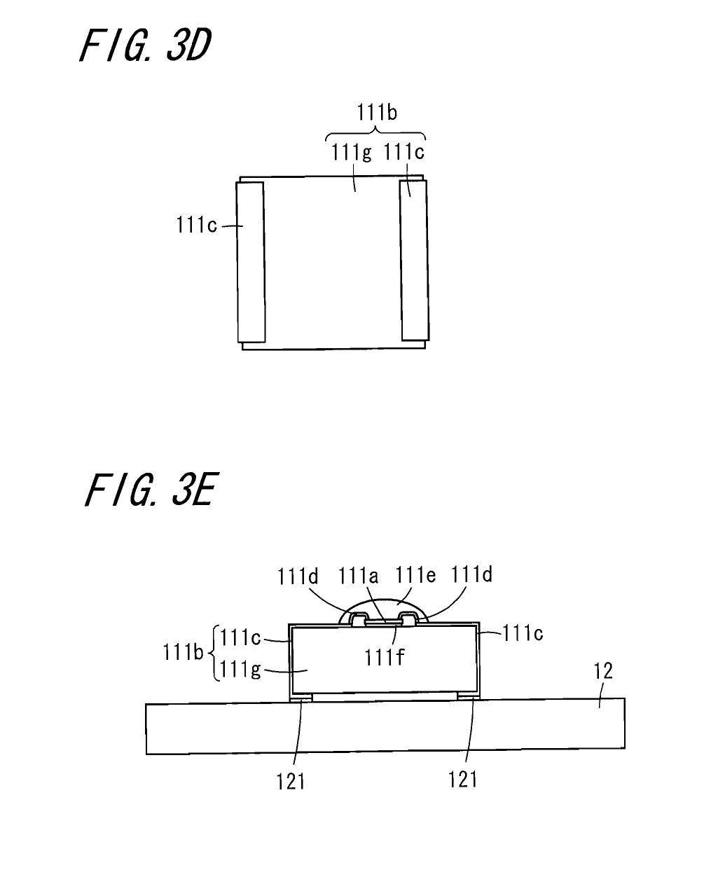

FIG. 3A is a view showing the positional relationship between the LED chip 111a supported by the base support 111b and the lens 112.

The base support 111b is a member for supporting the LED chip 111a. In the base support 111b, its support surface for supporting the LED chip 111a is square-shaped when viewed in a plan view in the direction X, and a length L1 of a side of the square shape is set at 3 mm, for example. Moreover, the height of the base support 111b is set at 1 mm, for example.

FIGS. 3B to 3D are views showing the base support 111b and the LED chip 111a, of which FIG. 3B is a plan view, FIG. 3C is a front view, and FIG. 3D is a bottom view. As shown in FIGS. 3B to 3D, the base support 111b includes a base main body 111g made of ceramic, resin, or the like, and two electrodes 111c disposed on the base main body 111g, and, the LED chip 111a is secured to a midportion of the top surface of the base main body 111g serving as the support surface of the base support 111b by a bonding member 111f. The two electrodes 111c, which are spaced apart, are each so formed as to extend over the top surface, side surface, and bottom surface of the base main body 111g.

Two terminals (not shown) of the LED chip 111a are connected to their respective two electrodes 111c by two bonding wires 111d. The LED chip 111a and the bonding wire 111d are sealed with a transparent resin 111e such as silicon resin.

FIG. 3E shows the LED chip 111a and the base support 111b mounted on the printed circuit board 12. The LED chip 111a is mounted on the printed circuit board 12, with the base support 111b lying between them, for emitting light in a direction away from the printed circuit board 12. When the light-emitting device 11 is viewed in a plan view in the direction X, the LED chip 111a is located centrally of the base support 111b. In the plurality of light-emitting devices 11, their LED chips 111a can be controlled on an individual basis in respect of light emission. This allows the backlight unit 1 to perform local dimming control.

The LED chip 111a and the base support 111b can be mounted on the printed circuit board 12 by applying solder on each of two connection terminal portions 121 formed in a conductive-layer pattern on the printed circuit board 12, and placing the base support 111b and the LED chip 111a fixed to the base support 111b on the printed circuit board 12 so that the two electrodes 111c formed on the bottom surface of the base main body 111g are brought into registry with their respective solders by an automated machine (not shown), for example. The printed circuit board 12 carrying the base support 111b and the LED chip 111a fixed to the base support 111b is delivered to a reflow bath capable of infrared radiation, and the solder is heated to a temperature of about 260° C., whereby the base support 111b is soldered to the printed circuit board 12.

The lens 112, which is disposed in contact with the LED chip 111a so as to cover the base support 111b supporting the LED chip 111a by means of insert molding, allows light emitted from the LED chip 111a to undergo reflection or refraction in a plurality of directions. That is, the lens 112 effects light diffusion. The lens 112 is a transparent lens made, for example, of silicon resin or acrylic resin.

The lens 112 is shaped in a substantially cylindrical form, having a top surface 112a which faces the liquid-crystal panel 2 and is curved so as to provide a central recess, and a side surface 112b kept in parallel with an optical axis S of the LED chip 111a, and, a diameter L2 of its section perpendicular to the optical axis S is set at 10 mm, for example. The lens 112 is so formed as to extend outward relative to the base support 111b. That is, the lens 112 is larger than the base support 111b with respect to a direction perpendicular to the optical axis S of the LED chip 111a (the diameter L2 of the lens 112 is greater than the length L1 of one side of the support surface of the base support 111b). Thus, where the lens 112 is so formed as to extend outward relative to the base support 111b, light emitted from the LED chip 111a can be diffused over an even wider range by the lens 112.

Moreover, a height H1 of the lens 112 is set at 4.5 mm, for example, which is smaller than the diameter L2. In other words, the lens 112 is so configured that the length in a direction perpendicular to the optical axis S of the LED chip 111a (the diameter L2) is greater than the height H1. Light incident on the lens 112 is diffused in a direction intersected by the optical axis S in the interior of the lens 112.

The reason why the diameter L2 is set to be greater than the height H1 as above described is to make the backlight unit 1 lower in profile, as well as to ensure that light is applied evenly to the liquid-crystal panel 2. In order to make the backlight unit 1 lower in profile, the height H1 of the lens 112 needs to be minimized; that is, the lens 112 needs to be thinned as much as possible. However, the reduction in thickness of the lens 112 is likely to cause illuminance variations at the back 22 of the liquid-crystal panel 2, which may result in lack of uniformity in brightness at the front 21 of the liquid-crystal panel 2. Especially in a case where a distance between the adjacent LED chips 111a is long, a region between the LED chips 111a arranged adjacent each other at the back 22 of the liquid-crystal panel 2 is located far away from the LED chip 111a, wherefore the quantity of light applied to that region becomes small, which is likely to cause illuminance (brightness) variations between that region and a region close to the LED chip 111a. In order to ensure that the region located far away from the LED chip 111a is irradiated with light emitted from the LED chip 111a via the lens 112, it is necessary to increase the diameter L2 of the lens 112 to a certain extent, and accordingly, in this embodiment, the slimming-down of the backlight unit 1 and uniform application of light to the liquid-crystal panel 2 can be achieved by setting the diameter L2 to be greater than the height H1 in the lens 112.

If the diameter L2 of the lens 112 is set to be smaller than the height H1 of the lens 112, it will be difficult to achieve the slimming-down of the backlight unit 1 and uniform light application, and in addition, in the process of insert molding for forming the lens 112 in alignment with the LED chip 111a, the lens and the LED chip are likely to get out of balance. Furthermore, when the light-emitting portion 111 composed of the LED chip 111a, the base support 111b, and the lens 112 formed by means of insert molding is soldered to the printed circuit board 12, they are likely to get out of balance, which results in assembly problems.

The top surface of the lens 112 includes a recess portion 1121, a first curved portion 1122, and a second curved portion 1123. In the lens 112, the top surface 112a curved so as to provide a central recess comprises a first region where reaching light is reflected for its exit from the side surface 112b and a second region where reaching light is refracted outward for its exit from the top surface 112a. The first region is formed in the first curved portion 1122, and the second region is formed in the second curved portion 1123.

The recess portion 1121 is formed centrally of the top surface 112a opposed to the liquid-crystal panel 2, and the center of the recess portion 1121 (viz., the optical axis of the lens 112) is located on the optical axis S of the LED chip 111a. The bottom surface of the recess portion 1121 is circularly shaped in parallel with the light-emitting surface of the LED chip 111a, and its diameter L3 is set at 1 mm, for example. By way of another embodiment of the invention, instead of having the circularly shaped bottom surface, the recess portion 1121 may by defined by a lateral surface of a cone, the tip of which protrudes toward the LED chip 111a from an imaginary circular base.

The recess portion 1121 is intended to apply light to that region of the diffusion plate 3, which is an illumination object, which faces the recess portion 1121. However, since the recess portion 1121 is a part opposed to the LED chip 111a, when most of light emitted from the LED chip 111a reaches the recess portion 1121, and most part of the reaching light passes directly therethrough, then the illuminance of the region facing the recess portion 1121 is significantly increased. With this in view, the shape of the recess portion 1121 should preferably be defined by a lateral surface of a cone as above described. In the case of defining the shape of the recess portion 1121 by the lateral surface of the cone, most of light is reflected from the recess portion 1121, wherefore the quantity of light which passes through the recess portion 1121 is decreased, and consequently the illuminance of the region facing the recess portion 1121 can be regulated.

The first curved portion 1122 is an annular curved surface which merges with the outer edge of the recess portion 1121, and this curved surface gradually extends toward one side of the optical axis S (toward the liquid-crystal panel 2) in a direction from the optical axis S of the LED chip 111a to the outside so as to provide a convexity pointing inwardly toward one side of the optical axis S. As used herein, the term “outer edge” refers to an outermost part of the recess portion with respect to the optical axis S when viewed in a plan view in the direction of the optical axis S, which is defined by the perimeter of a circle about the optical axis S. The curved surface is designed for total reflection of light emitted from the LED chip 111a.

More specifically, out of light emitted from the LED chip 111a, light which has reached the first curved portion 1122 is totally reflected from the first curved portion 1122, is transmitted through the side surface 112b of the lens, and is directed toward a first reflecting portion 1181 of the first reflective member 118 as will hereafter be described. Upon reaching the first reflecting portion 1181, the light is diffused by the first reflecting portion 1181, and, part of the diffused light is applied to that region of the diffusion plate 3 acting as the illumination object which is not opposed to the LED chip 111a but opposed to the first reflecting portion 1181. Moreover, another part of the diffused light is directed toward a second reflecting portion 1182 of the first reflective member 118 as will hereafter be described, and is diffused by the second reflecting portion 1182, and, the diffused light is applied to that region of the diffusion plate 3 acting as the illumination object which is not opposed to the LED chip 111a but opposed to the second reflecting portion 1182. In this way, the quantity of light applied to the region which is not confronted by the LED chip 111a can be increased.

In the interest of total reflection of light emitted from the LED chip 111a, the first curved portion 1122 is so configured that the angle of incidence of light emitted from the LED chip 111a is greater than or equal to a critical angle φ. For example, given that acrylic resin is used as the material for the lens 112, the refractive index of the acrylic resin is 1.49, whereas the refractive index of air is 1, wherefore the following relationship is obtained: sin φ=1/1.49. A critical angle φ of 42.1° is derived from this relational expression, and correspondingly the first curved portion 1122 is so configured that the incident angle is greater than or equal to 42.1°. On the other hand, for example, given that silicon resin is used as the material for the lens 112, the refractive index of the silicon resin is 1.43, whereas the refractive index of air is 1, wherefore the following relationship is obtained: sin φ=1/1.43. A critical angle φ of 44.4° is derived from this relational expression, and correspondingly the first curved portion 1122 is so configured that the incident angle is greater than or equal to 44.4°.

The second curved portion 1123 is an annular curved surface which merges with the outer edge of the first curved portion 1122, and extends toward the other side of the optical axis S (located away from the liquid-crystal panel 2) in a direction from the optical axis S of the LED chip 111a to the outside so as to provide a convexity pointing outwardly toward one side of the optical axis S.

In this embodiment, the lens 112 has a reflection portion 119 for reflecting light formed over the entire bottom thereof. The reflection portion 119 can be formed by means of application of a sheet of silver or aluminum, vapor deposition of aluminum, or otherwise. The thickness of the reflection portion 119 is set at 50 μm, for example, and the reflection portion 119 reflects visible light emitted from the LED chip 111a at a reflectivity (total reflectivity) of greater than or equal to 98%. Note that aluminum vapor deposition is effected by heating aluminum in a vessel maintained under vacuum so that it adheres to the bottom of the lens 112 that is a target of the vapor deposition.

Out of light emitted from the LED chip 111a, light which has reached the second curved portion 1123 is refracted in a direction toward the light-emitting portion 111 when passing through the second curved portion 1123 so as to travel toward the diffusion plate 3 and the first reflective member 118. Upon reaching the first reflective member 118, the light is diffused for travel toward the diffusion plate 3. The light thusly directed toward the diffusion plate 3 by the second curved portion 1123 is mainly applied to a region of the diffusion plate 3 that differs from the region irradiated with light from the recess portion 1121 and the first curved portion 1122, which makes up for the insufficiency of light quantity. Note that the second curved portion 1123 is required to allow transmission of light, and is therefore configured so that the incident angle is smaller than 42.1° to avoid total reflection of light emitted from the LED chip 111a.

Thus, in the lens 112, the outer edge of the recess portion 1121 is formed with the first curved portion 1122 capable of totally reflecting light emitted from the LED chip 111a for its travel toward the side surface 112b of the lens 112, and the outer edge of the first curved portion 1122 is formed with the second curved portion 1123 capable of refracting light emitted from the LED chip 111a. In general, the LED chip 111a has high directivity, and the quantity of light in the vicinity of the optical axis S is very large, and thus, the quantity of light decreases as the exit angle of light with respect to the optical axis S is increased. Accordingly, in order to increase the quantity of light applied to a region located relatively far away from the optical axis S of the LED chip 111a (viz., the optical axis of the lens 112), rather than light having a large exit angle with respect to the optical axis S, light having a small exit angle with respect to the optical axis S needs to directed toward that region. In this embodiment, as has already been described, since the first curved portion 1122 capable of totally reflecting light for its travel toward that region is formed in contiguous relation around the recess portion 1121 through which the optical axis S passes, it is possible to increase the quantity of light applied to that region. By contrast, if the second curved portion 1123 is formed around the recess portion 1121 in contiguous relation, and the first curved portion 1122 is formed around the second curved portion 1123 in contiguous relation, light traveling toward the first curved portion 1122 will exhibit a larger exit angle with respect to the optical axis S, with a consequent decrease in the quantity of light applied to that region through total reflection in the first curved portion 1122.

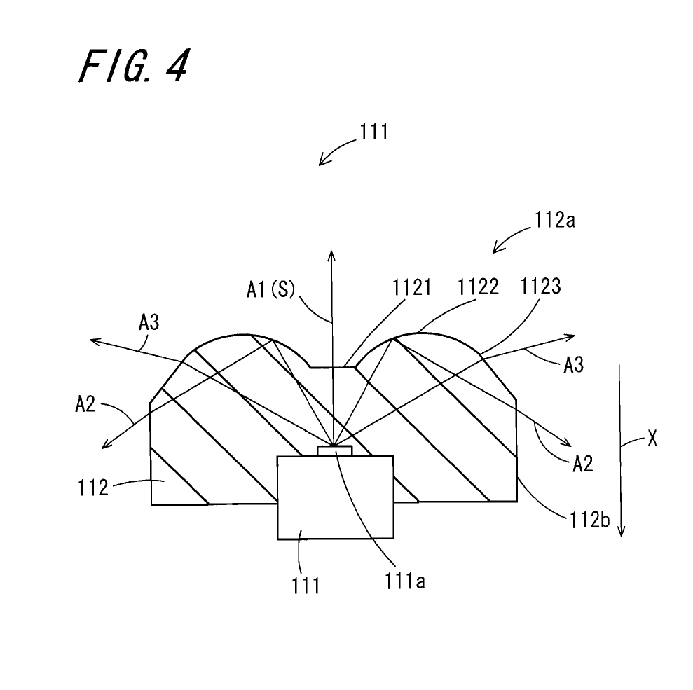

FIG. 4 is a view for explaining the optical path of light emitted from the LED chip 111a. Light emitted from the LED chip 111a enters the lens 112, and is then diffused by the lens 112. Specifically, out of light incident on the lens 112, light which has reached the recess portion 1121 at the top surface 112a opposed to the liquid-crystal panel 2 is caused to exit in a direction indicated by arrow A1 for its travel toward the liquid-crystal panel 2; light which has reached the first curved portion 1122 is reflected therefrom to exit from the side surface 112b for its travel in a direction indicated by arrow A2; and light which has reached the second curved portion 1123 is refracted outward (in a direction away from the LED chip 111a) to exit in a direction indicated by arrow A3 for its travel toward the liquid-crystal panel 2.

Moreover, in this embodiment, the LED chip 111a and the lens 112 are formed in a highly accurate predetermined alignment with each other in a manner such that the center of the lens 112 (viz., the optical axis of the lens 112) is located on the optical axis S of the LED chip 111a, and the lens 112 is brought into contact with the LED chip 111a. Examples of the method of forming the LED chip 111a and the lens 112 in a predetermined alignment with each other include insert molding technique and a process of fitting the LED chip 111a supported by the base support 111b to the lens 112 formed in a predetermined shape. In this embodiment, the LED chip 111a and the lens 112 are formed in a predetermined alignment with each other by the insert molding technique.

Molds used for insert molding are broadly classified into an upper mold and a lower mold. Insert molding is effected by pouring, from a resin inlet, a resin used as the raw material of the lens 112 into a space created when the upper mold and the lower mold are put together, while retaining the LED chip 111a. Alternatively, it is also possible to pour a resin used as the raw material of the lens 112 into a space created when the upper mold and the lower mold are put together from a resin inlet, while retaining the LED chip 111a supported by the base support 111b. In this way, where the LED chip 111a and the lens 112 are formed by the insert molding technique, the lens 112 can be brought into highly accurate alignment with the LED chip 111a while making contact therewith. This allows the backlight unit 1 to reflect and refract light emitted from the LED chip 111a with high accuracy by the action of the lens 112 kept in contact with the LED chip 111a, and accordingly, even in the low-profile liquid-crystal display apparatus 100 in which a distance H3 from the diffusion plate 3 to the printed circuit board 12 is short (for example, H3 is set at 6 mm), the backlight unit 1 is capable of applying light to the display panel 2 with uniformity in light intensity in the planar direction.

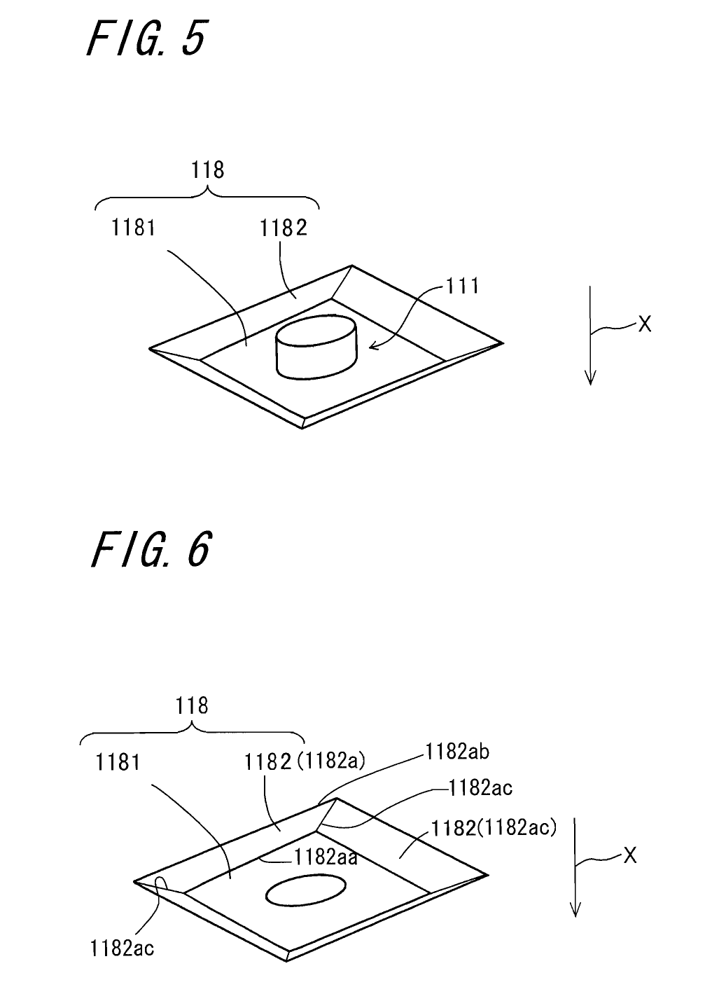

The first reflective member 118 will be described with reference to FIGS. 5 and 6. FIG. 5 is a perspective view of the first reflective member 118 and the light-emitting portion 111, and FIG. 6 is a perspective view of the first reflective member 118. The first reflective member 118 is a member for reflecting incident light. The first reflective member 118 exhibits high reflectivity, or ideally a reflectivity of 100%, for light radiating from the LED chip 111a. Note that the reflectivity of the material constituting the first reflective member 118 in itself can be measured in conformity to JIS K 7375.

The first reflective member 118 is made of high-luminance PET (Polyethylene Terephthalate), aluminum, or the like. The high-luminance PET is foamed PET containing a fluorescent agent, and examples thereof include E60V (product name) manufactured by TORAY Industries, Inc. The first reflective member 118 has a thickness in a range of 0.1 to 0.5 mm, for example. Moreover, in the light-emitting devices 11 arranged adjacent each other, given that the length of a side of the square light-emitting device 11 is 55 mm, then the spacing between the middle points of their respective first reflective members 118 falls in the range of 55 mm to 58 mm, for example.

The first reflective member 118 has a polygonal outer shape, for example, a square outer shape when viewed in a plan view in the direction X. The first reflective member 118 comprises the first reflecting portion 1181 which is “a base portion” according to the invention and the second reflecting portion 1182 which is “an inclined portion” according to the invention. The first reflecting portion 1181, which has a square outer shape when viewed in a plan view in the direction X, extends in a direction perpendicular to the optical axis S of the LED chip 111a on the printed circuit board 12. The second reflecting portion 1182, which surrounds the first reflecting portion 1181, is so shaped that, with increasing a distance from the LED chip 111a in a direction perpendicular to the direction X, it extends gradually toward the diffusion plate 3 away from the printed circuit board 12 while being inclined at an angle to the direction of the optical axis S of the LED chip 111a. Accordingly, the first reflective member 118 composed of the first reflecting portion 1181 and the second reflecting portion 1182 has the form of an upside-down dome, the center of which is coincident with the LED chip 111a.

The first reflecting portion 1181 is so configured that each side of a square defining its shape as viewed in a plan view in the direction X becomes parallel to the direction of rows or columns of the matrix of a plurality of LED chips 111a. Moreover, the first reflecting portion 1181 is formed along the printed circuit board 12, and has a circular opening located in the middle thereof as viewed in a plan view in the direction X. The circular opening has a diameter length in a range of 10 mm to 13 mm, which is substantially equal to the diameter length L2 of the lens 112 covering the LED chip 111a, and thus, when the first reflective member 118 is placed on the printed circuit board 12 after mounting the light-emitting portion 111 including the lens 112 on the printed circuit board 12, the light-emitting portion 111 is inserted into this opening.

The second reflecting portion 1182 is composed of four trapezoidal flat plates 1182a each having an isosceles-trapezoidal flat main surface. Accordingly, that surface of the second reflecting portion 1182 which faces the light-emitting portion 111 is made up of four planes.

In each of the trapezoidal flat plates 1182a, out of two opposed parallel sides of the isosceles trapezoid, the shorter one, namely a short base 1182aa merges with each side of the square first reflecting portion 1181. In each of the trapezoidal flat plates 1182a, out of two opposed parallel sides of the isosceles trapezoid, the longer one, namely a long base 1182ab lies farther away than the first reflecting portion 1181 with respect to the printed circuit board 12 in the direction X; that is, located closer to the diffusion plate 3 acting as the illumination object. The adjacent trapezoidal flat plates 1182a are continuous with each other at two opposed non-parallel sides of the isosceles trapezoid, namely the legs 1182ac thereof.

For example, an angle of inclination θ3 between the trapezoidal flat plate 1182a and the printed circuit board 12 falls in the range from 45° to 85°, and this inclination angle θ3 is set at 80° in this embodiment. Moreover, in this embodiment, a height H4 of the first reflective member 118 falls in the range of 2.5 to 5 mm, for example. Note that the height H4 is a distance in the direction X between a part of the second reflecting portion 1182 which lies farthest from the surface of the first reflecting portion 1181 in the direction X and the surface of the first reflecting portion 1181 in the direction X.

The value of the sum of the areas of the four trapezoidal flat plates 1182a projected on the diffusion plate 3 acting as the illumination object is smaller than the area of the first reflecting portion 1181 having the shape of a square with a circular opening formed in the middle thereof projected on the diffusion plate 3 acting as the illumination object. That is, the projected area of the first reflecting portion 1181 relative to the illumination object is greater than the projected area of the second reflecting portion 1182 relative to the illumination object.

In this embodiment, the length of a side of the square light-emitting device 11 is 55 mm, and the inclination angle θ3 is 80°. Accordingly, given that the height H4 of the first reflective member 118 is 5 mm, then the area of a single trapezoidal flat plate 1182a constituting the second reflecting portion 1182 projected on the diffusion plate 3 acting as the illumination object can be expressed in equation form as: {55+(55−2×5/tan θ3)}×(5/tan θ3)×½≈47.7 [mm²]. Hence it follows that the area of the second reflecting portion 1182 projected on the diffusion plate 3 acting as the illumination object can be expressed in equation form as: 47.7×4=190.8 [mm²]. On the other hand, given that the diameter of the circular opening formed in the first reflecting portion 1181 is 10 mm, then the area of the first reflecting portion 1181 projected on the diffusion plate 3 acting as the illumination object can be expressed in equation form as: (55−2×5/tan θ3)×(55−2×5/tan θ3)−5×5×3.14≈2755.6 [mm²]. Accordingly, the projected area of the first reflecting portion 1181 relative to the illumination object is 10 or more times greater than the projected area of the second reflecting portion 1182 relative to the illumination object.

It is preferable that the thusly constructed first reflective members 118 provided in their respective light-emitting devices 11 are integrally molded. As the method of integrally molding a plurality of first reflective members 118, where the first reflective member 118 is made of foamed PET, extrusion molding technique can be adopted, and, where the first reflective member 118 is made of aluminum, press working technique can be adopted. In this way, by integrally molding the first reflective members 118 provided in their respective light-emitting devices 11, it is possible to improve the accuracy of placement positions of the light-emitting portions 111 relative to their respective first reflective members 118, and thereby allow the first reflective member 118 to reflect light in a manner such that a higher level of uniformity in brightness is ensured in the illumination object in the planar direction. In addition, by virtue of the integral molding of the first reflective members 118, it is possible to reduce the number of process steps required for installation of the first reflective member 118 during assembly of the backlight unit 1, and thereby increase the efficiency of assembly operation.

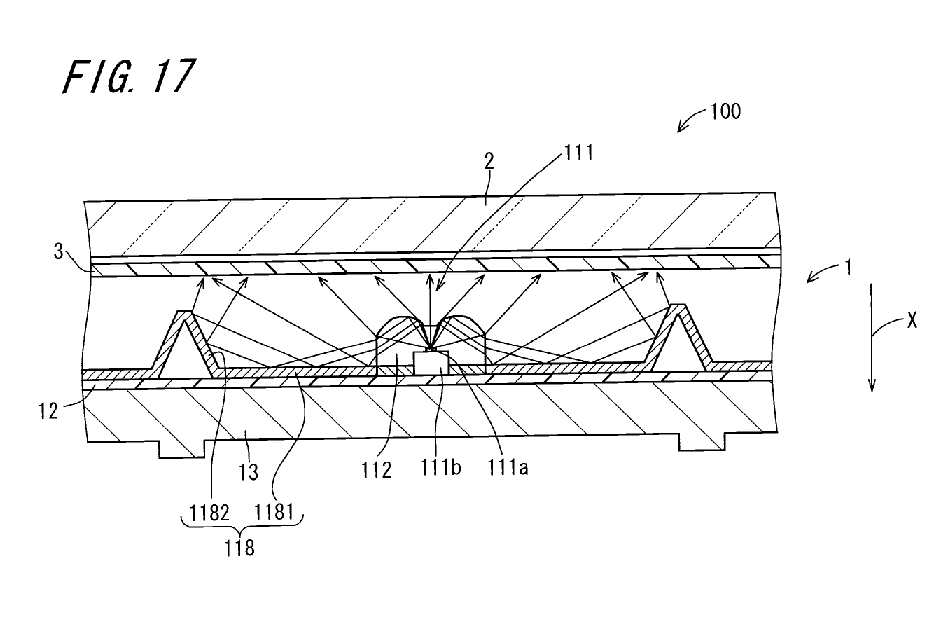

According to the backlight unit 1 having the light-emitting devices 11 thusly constructed, out of light emitted from the lens 112, light emitted from the side surface 112b of the lens 112 is partly incident on the first reflecting portion 1181 of the first reflective member 118, and is diffused. Since the first reflecting portion 1181 extends along the printed circuit board 12 in perpendicular relation to the optical axis S1 of the lens 12, it follows that part of the light diffused on the first reflecting portion 1181 is applied to a part of the diffusion plate 3 acting as the illumination object on which is projected the first reflecting portion 1181 as viewed in a plan view in the direction X. That is, where the optical path of part of the light emitted from the side surface 112b of the lens 112 of the light-emitting portion 111 is concerned, as shown in FIG. 17, the light is incident on the first reflecting portion 1181, is reflected therefrom, and is directed toward the illumination object.

The other part of the light diffused on the first reflecting portion 1181 is incident on the second reflecting portion 1182 surrounding the outer edge of the first reflecting portion 1181. As used herein, the term “outer edge of the first reflecting portion 1181” refers to an outermost part of the first reflecting portion 1181 with respect to the optical axis S when viewed in a plan view in the direction of the optical axis S, that is, a boundary between the first reflecting portion 1181 and the second reflecting portion 1182. Since the second reflecting portion 1182 is so shaped that it extends away from the printed circuit board 12 as it runs outward (with distance from the LED chip 111a), and that its surface facing the light-emitting portion 111 is composed of a plurality of planes, it follows that light incident on the second reflecting portion 1182 is reflected therefrom toward the liquid-crystal panel 2 disposed in parallel with the printed circuit board 12, so that it can be applied to a part of the diffusion plate 3 acting as the illumination object on which is projected the second reflecting portion 1182 as viewed in a plan view in the direction X. That is, where the optical path of part of the light emitted from the side surface 112b of the lens 112 of the light-emitting portion 111 is concerned, as shown in FIG. 17, the light is incident on the first reflecting portion 1181, is reflected therefrom, is incident on the second reflecting portion 1182, is reflected therefrom, and is eventually directed toward the illumination object.

Thus, in this embodiment, even if the second reflecting portion 1182 is given a flat-plate shape rather than a substantially arc-like shape, that region of the diffusion plate 3 acting as the illumination object on which is projected the first reflecting portion 1181 as viewed in a plan view in the direction X, as well as that region thereof on which is projected the second reflecting portion 1182 as viewed in a plan view in the direction X, can be irradiated with a sufficient quantity of light. Accordingly, the backlight unit 1 is capable of applying light to the illumination object with uniformity in light intensity in the planar direction, and can be also made lower in profile. That is, according to this embodiment, by the reflecting action of the flat first reflecting portion 1181, light emitted from the light-emitting portion 111 is able to travel as far away from the light-emitting portion 111 as possible in the planar direction, and, in a distant place where the light reaches, reflection is caused by the flat second reflecting portion 1182, whereby light can be supplied to that region of the diffusion plate 3 acting as the illumination object which lies far away from the light-emitting portion 111 where the brightness tends to be low. In consequence, even in the low-profile backlight unit 1, a sufficient level of uniformity in brightness can be ensured in the planar direction.

Moreover, in this embodiment, the area of the first reflecting portion 1181 projected on the illumination object is greater than the area of the second reflecting portion 1182 projected on the illumination object. The larger the projected area of the first reflecting portion 1181 is, the larger the area of irradiation of light emitted from the lens 112 on the first reflecting portion 1181 is, wherefore the quantity of light applied to the illumination object by the reflecting action of the first reflecting portion 1181 is increased, and the quantity of light applied to the second reflecting portion 1182 by the reflecting action of the first reflecting portion 1181 is also increased, and consequently, the quantity of light around the first reflective member 118 can be increased for attainment of a higher level of uniformity in brightness in the planar direction of the illumination object.

Next, a second embodiment of the invention will be described. The second embodiment is provided with a reflective member 113 as will hereafter be described instead of the first reflective member 118, and otherwise the second embodiment is structurally identical with the preceding first embodiment, wherefore the components that play the same or corresponding roles as in the first embodiment will be identified with the same reference symbols, and the descriptions thereof will be omitted.

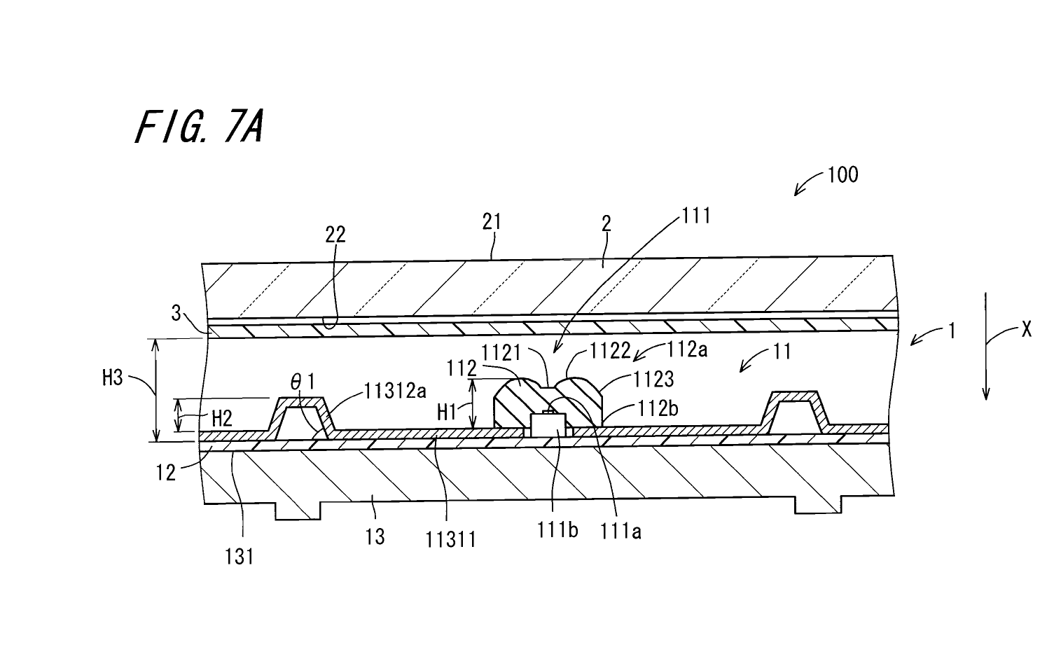

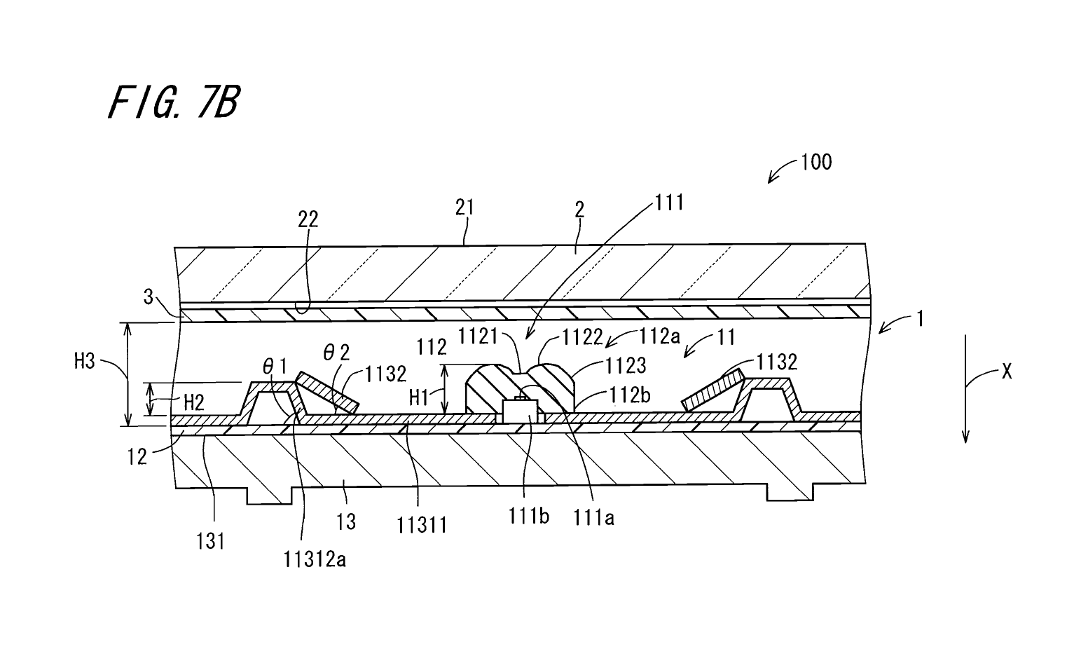

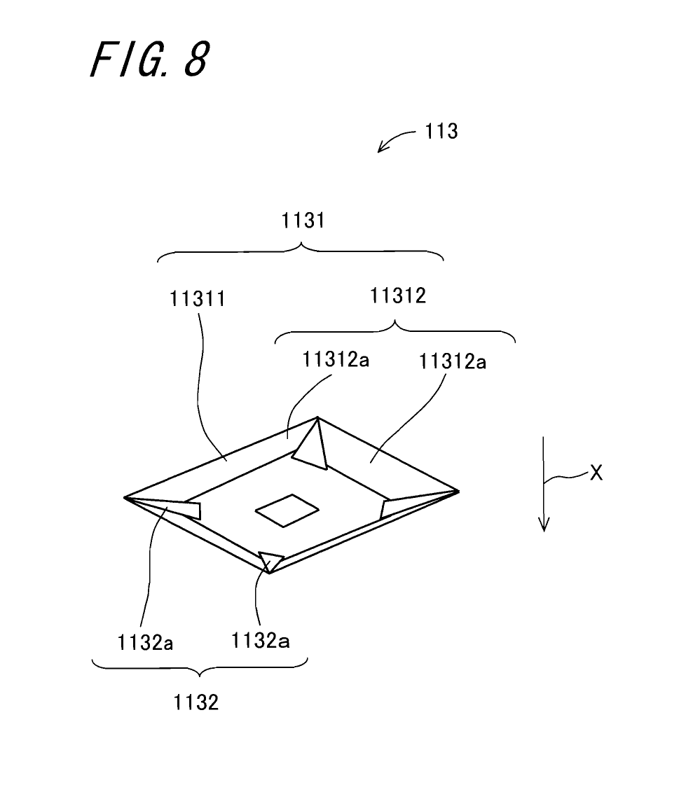

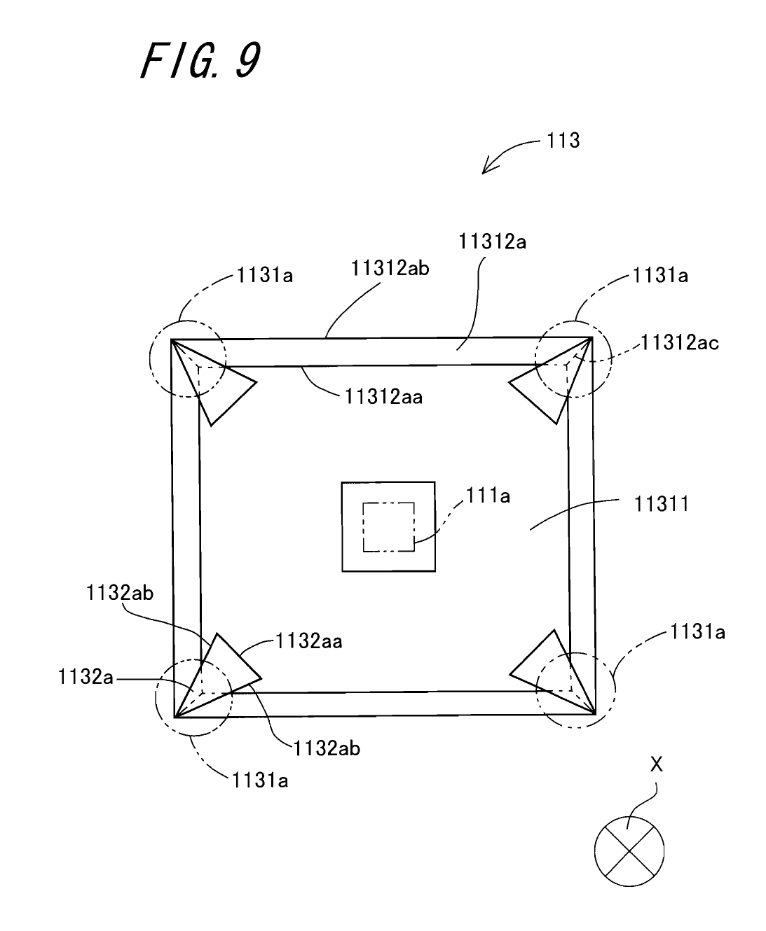

FIG. 7A is a view schematically showing the section of the liquid-crystal display apparatus 100 in accordance with the second embodiment taken along the line A-A of FIG. 1. FIG. 7B is a view schematically showing the section of the liquid-crystal display apparatus 100 in accordance with the second embodiment taken along the line B-B of FIG. 1. FIG. 8 is a perspective view of the reflective member 113, and FIG. 9 is a view showing the reflective member 113 as viewed in a plan view in the direction X. The reflective member 113 is a member for reflecting incident light. The reflective member 113 exhibits high reflectivity, or ideally a reflectivity of 100%, for light radiating from the LED chip 111a.

The reflective member 113 is made of high-luminance PET, aluminum, or the like. The reflective member 113 has a thickness in a range of 0.1 to 0.5 mm, for example. Moreover, a height H2 of the reflective member 113 in the direction X is set at 3.5 mm, for example. In addition, in the light-emitting devices 11 arranged adjacent each other, given that the length of a side of the square light-emitting device 11 is 55 mm, then the spacing between the middle points of their respective reflective members 113 falls in the range of 55 mm to 58 mm, for example.

The reflective member 113 includes a first reflecting member 1131 having a polygonal outer shape, for example, a square outer shape when viewed in a plan view in the direction X, and a second reflecting member 1132 formed so as to extend from each corner 1131a of the first reflecting member 1131 toward the LED chip 111a with an increasingly large width when viewed in a plan view in the direction X.

The first reflecting member 1131 comprises a first reflecting portion 11311 having a square outer shape when viewed in a plan view in the direction X, and a second reflecting portion 11312 which surrounds the first reflecting portion 11311 and extends with inclination so as to gradually separate from the printed circuit board 12 with increasing a distance from the LED chip 111a. The first reflecting member 1131 composed of the first reflecting portion 11311 and the second reflecting portion 11312 has the form of an upside-down dome, the center of which is coincident with the LED chip 111a.

The first reflecting portion 11311 is so configured that each side of a square defining its shape as viewed in a plan view in the direction X becomes parallel to the direction of rows or columns of the matrix arrangement of a plurality of LED chips 111a. Moreover, the first reflecting portion 11311 is formed along the printed circuit board 12, and has a square opening located in the middle thereof as viewed in a plan view in the direction X. One side of the square opening has a length in a range of 3 mm to 5 mm, which is substantially equal to the length L1 of one side of the base support 111b for supporting the LED chip 111a, so that the base support 111b is inserted into this opening. That is, in this embodiment, the reflection portion 119 is not provided at the bottom of the lens 112, and thus the first reflecting portion 11311 abuts on the bottom of the lens 112. Except for the difference in opening shape, the first reflecting member 1131 is substantially identical in form with the first reflective member 118.

The second reflecting portion 11312 is composed of four trapezoidal flat plates 11312a each having a trapezoidal main surface. In each of the trapezoidal flat plates 11312a, a shorter base 11312aa of the trapezoid merges with each side of the square first reflecting portion 11311, and, a longer base 11312ab thereof lies farther away than the first reflecting portion 11311 with respect to the printed circuit board 12 in the direction X. The adjacent trapezoidal flat plates 11312a are continuous with each other at their legs 11312ac. An angle of inclination θ1 between the trapezoidal flat plate 11312a and the printed circuit board 12 is set at 80°, for example.

The second reflecting member 1132 is composed of four isosceles-triangular flat plates 1132a each having an isosceles-triangular main surface. The isosceles-triangular flat plates 1132a are disposed at their respective corners 1131a of the first reflecting member 1131. In each of the isosceles-triangular flat plates 1132a, a base 1132aa makes contact with the first reflecting portion 11311, and two lateral sides 1132ab make contact with two trapezoidal flat plates 11312a, respectively, located on opposite sides of the corner 1131a. An angle of inclination θ2 of the isosceles-triangular flat plate 1132a is smaller than the inclination angle θ1. The shape of the second reflecting member 1132 is not limited to an isosceles triangle, but may be of another form so long as it is capable of ensuring adequate light quantity at the corner 1131a.

It is preferable that the thusly constructed reflective members 113 provided in their respective light-emitting devices 11 are integrally molded. As the method of integrally molding a plurality of reflective members 113, where the reflective member 113 is made of foamed PET, extrusion molding technique can be adopted, and, where the reflective member 113 is made of aluminum, press working technique can be adopted. In this way, by integrally molding the reflective members 113 provided in their respective light-emitting portions 111, it is possible to improve the accuracy of placement positions of the plurality of light-emitting portions 111 relative to the printed circuit board 12, and it is also possible to reduce the number of process steps required for installation of the reflective member 113 during assembly of the backlight unit 1, and thereby increase the efficiency of assembly operation.

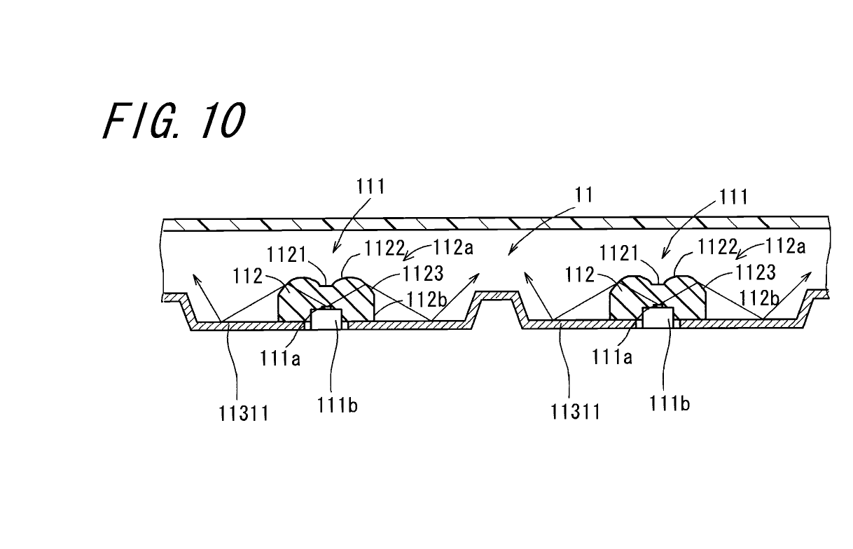

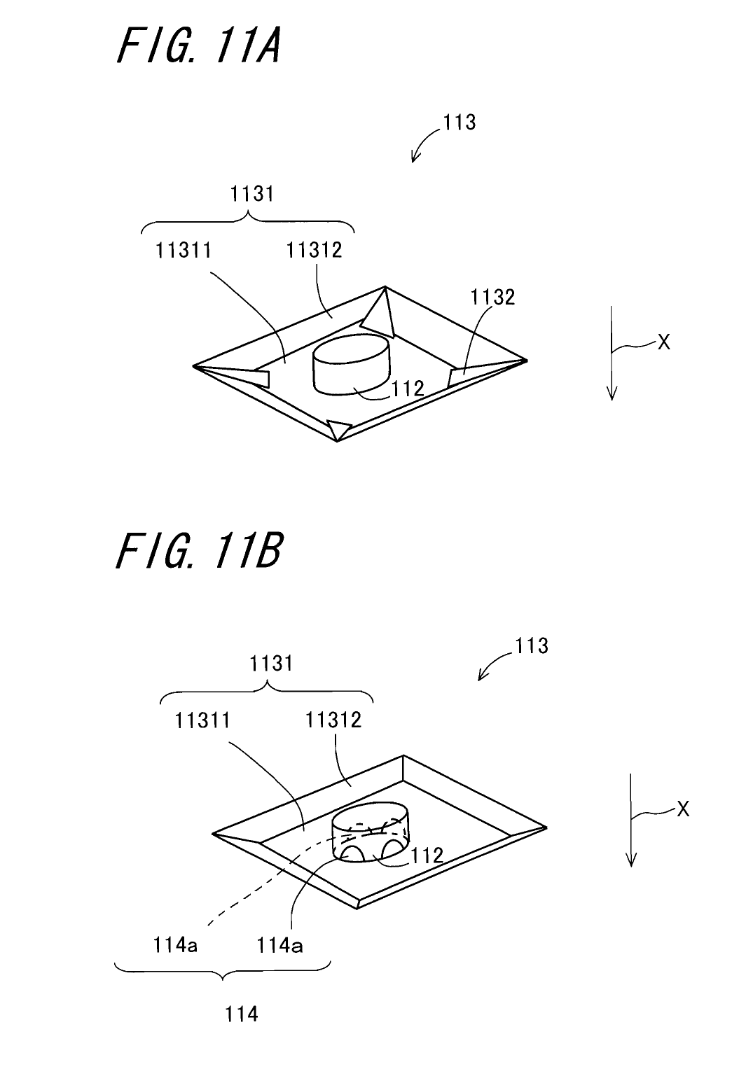

Referring to FIGS. 4 and 10, a description will be given below as to the optical path of light emitted from the LED chip 111a in the liquid-crystal display apparatus 100 provided with the backlight unit 1 having the reflective member 113 thusly constructed.

In the backlight unit 1, out of light that has been emitted from the LED chip and entered the lens 112, light which has reached the recess portion 1121 at the top surface 112a opposed to the liquid-crystal panel 2 is caused to exit in a direction indicated by arrow A1 for its travel toward the liquid-crystal panel 2; light which has reached the first curved portion 1122 is reflected therefrom to exit from the side surface 112b for its travel in a direction indicated by arrow A2; and light which has reached the second curved portion 1123 is refracted outward to exit in a direction indicated by arrow A3 for its travel toward the liquid-crystal panel 2.

Then, out of the light emitted from the lens 112, the outgoing light from the side surface 112b (the exiting direction of this light is intersected by the optical axis S) is incident on the second reflecting portion 11312 of the reflective member 113. Since the second reflecting portion 11312 is so shaped that it extends away from the printed circuit board 12 as it runs outward (with distance from the LED chip 111a), it is possible to allow light incident on the second reflecting portion 11312 to reflect in a direction toward the liquid-crystal panel 2 disposed in parallel with the printed circuit board 12, and thereby increase the quantity of light in a region corresponding to the second reflecting portion 11312 in the planar direction.

Moreover, out of the light directed toward the second reflecting portion 11312, light traveling toward the corner 1131a of the first reflecting member 1131 is incident on the second reflecting member 1132 disposed at the corner 1131a. Since the second reflecting member 1132 is capable of reflecting incident light in a direction toward the liquid-crystal panel 2 disposed in parallel with the printed circuit board 12, it is possible to suppress a decrease in the quantity of light applied to a part of the liquid-crystal panel 2 which corresponds to the corner 1131a of the first reflecting member 1131. As a result, it is possible to apply light to the liquid-crystal panel 2 with uniformity in light intensity in the planar direction, while making the backlight unit 1 even lower in profile.

Moreover, in this embodiment, the height H2 of the reflective member 113 is lower than the height H1 of the lens 112. That is, the reflective member 113 lies closer to the printed circuit board 12 than the lens 112. Thus, in the light-emitting portions 111 arranged adjacent each other, as shown in FIG. 10, light from one of the light-emitting portions 111 is applied to the other, wherefore the adjacent light-emitting portions 111 complement each other in respect of the insufficiency of light quantity. This makes it possible to suppress a decrease in the quantity of light applied to the liquid-crystal panel 2, and thereby apply light to the liquid-crystal panel 2 with even higher uniformity in light intensity in the planar direction.

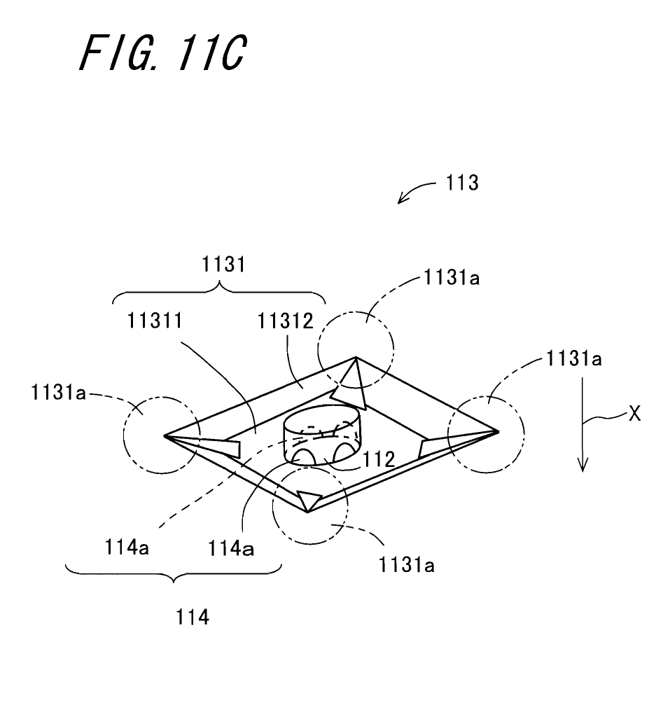

FIG. 11A shows the reflective member 113 having the second reflecting member 1132, and the lens 112. Such a backlight unit 1 may further include a light quantity adjustment member. The light quantity adjustment member is a member for adjusting the quantity of light incident on each portion of the reflective member 113. FIG. 11B shows an example of the light quantity adjustment member. In FIG. 11B, there are shown a light quantity adjustment member 114, the reflective member 113, and the lens 112.

The light quantity adjustment member 114 is composed of four semicircular members 114a each having a semicircular main surface and a predetermined thickness. Each of the semicircular members 114a is formed along a side surface of the cylindrical lens 112 and positioned so as not to face the corner 1131a of the first reflecting member 1131 (so as to face a side of the first reflecting member 1131 situated near the lens 112, for example). A rectilinear part of the semicircular member 114a makes contact with the first reflecting portion 11311. The semicircular member 114a is a light-transmittable member having minute asperities formed on its main surface, which acts to diffuse light. In consequence, the liquid-crystal panel 2 can be irradiated with light with uniformity in light intensity in the planar direction. Although the shape of the above-described semicircular member 114a is defined by a semicircle, the shape can be changed so long as it is ensured that the liquid-crystal panel 2 can be irradiated with light with uniformity in light intensity in the planar direction.

It is possible to adopt a configuration such as shown in FIG. 11C in which the second reflecting member 1132 is disposed at the corner 1131a of the first reflecting member 1131, and in addition the light quantity adjustment member is formed along the side surface of the lens 112. In this case, the liquid-crystal panel 2 can be irradiated with light with even higher uniformity in light intensity in the planar direction.

By way of another embodiment of the invention, the lens 112 may be designed to have the function of the light quantity adjustment member. That is, instead of having the semicircular member 114a, the lens 112 may be subjected to machining process to create minute asperities at the surface of a part thereof where the semicircular member 114a is to be formed.

Next, a third embodiment of the invention will be described. Except that a first reflecting member 115 and a reflecting sheet 116 as will hereafter be described are provided instead of the first reflecting member 1131, the third embodiment is structurally identical with the preceding second embodiment, wherefore the components that play the same or corresponding roles as in the second embodiment will be identified with the same reference symbols, and the descriptions thereof will be omitted.

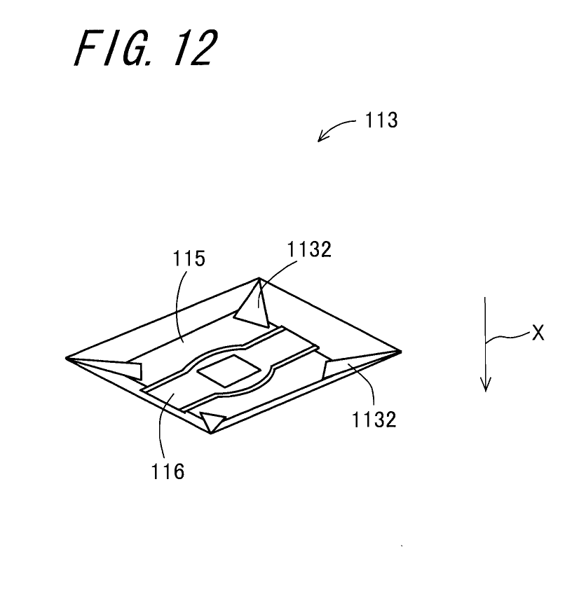

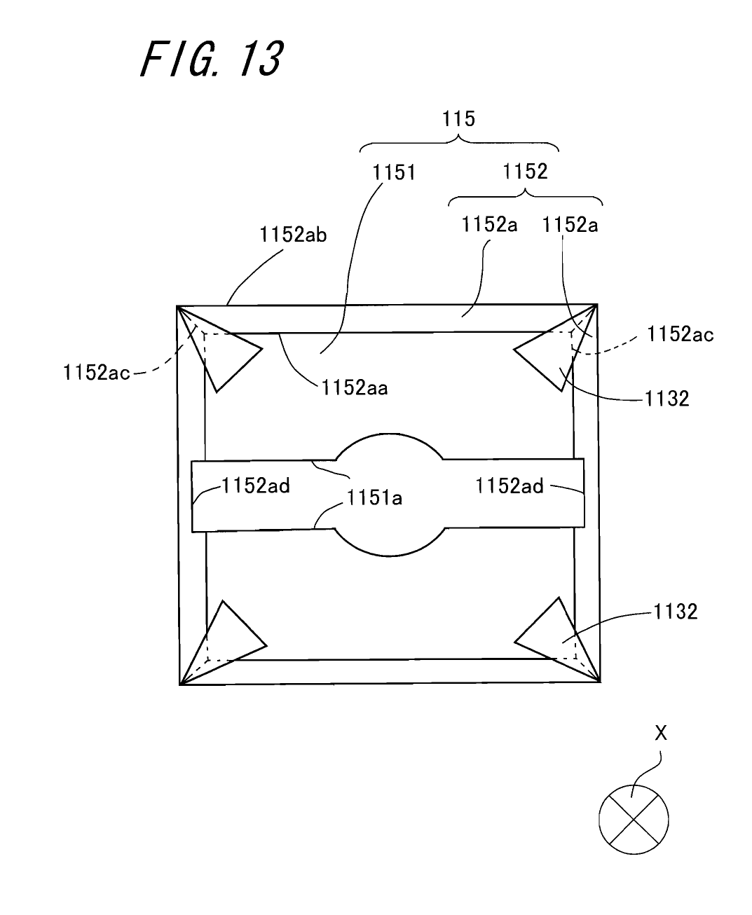

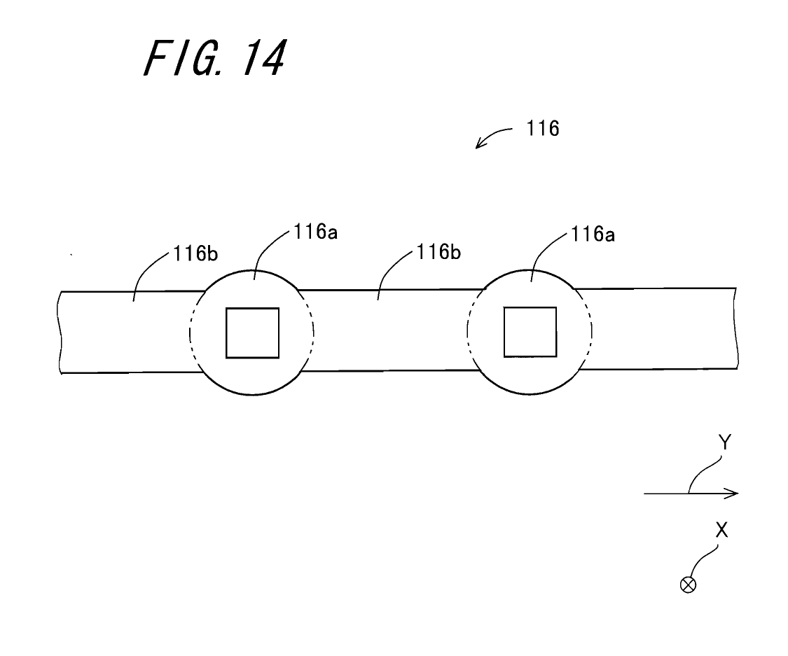

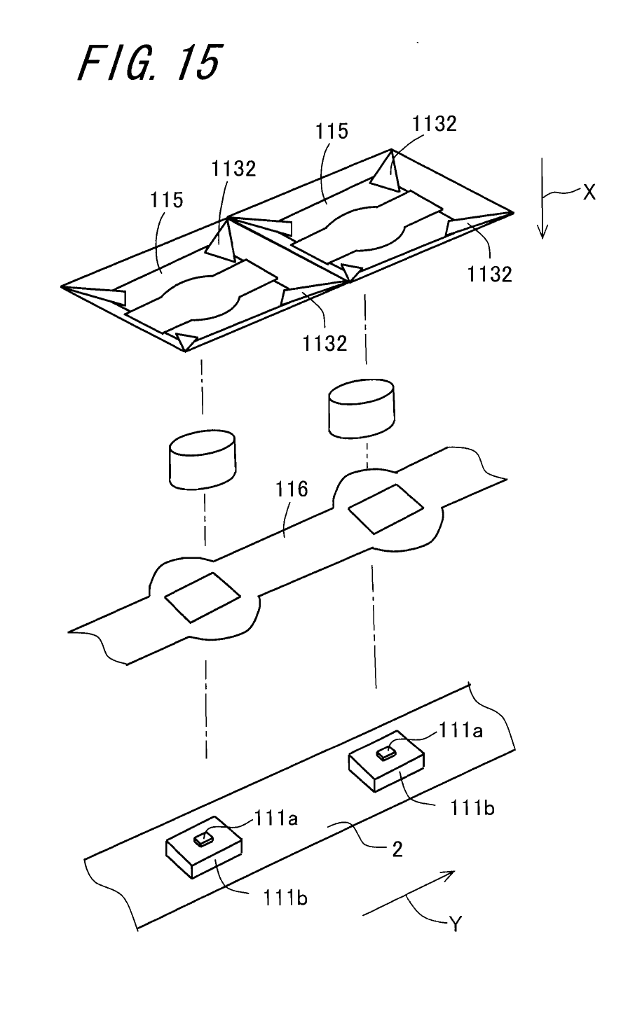

FIG. 12 is a perspective view of the first reflecting member 115 and the reflecting sheet 116. FIG. 13 is a view showing the first reflecting member 115 as viewed in a plan view in the direction X. FIG. 14 is a view showing the reflecting sheet 116 as viewed in a plan view in the direction X. FIG. 15 is an exploded perspective view of the reflective member 113.

In this embodiment, the reflective member 113 is composed of the first reflecting member 115, the reflecting sheet 116, and the second reflecting member 1132. As shown in FIG. 12, a combination of the first reflecting member 115 and the reflecting sheet 116 provides a configuration similar to the first reflecting member 1131 of the second embodiment.

As shown in FIGS. 14 and 15, the reflecting sheet 116 extends in a direction Y coincident with the direction of rows or columns of the matrix arrangement of a plurality of LED chips 111a, and is so formed as to surround each of the LED chips 111a. The reflecting sheet 116 includes: a plurality of circular parts 116a having the shape of a circle when viewed in a plan view in the direction X, on each of which the printed circuit board 12-sided bottom of each cylindrical lens 112 abuts; and a plurality of strip-like parts 116b acting as the connection between the adjacent circular parts 116a. The circular part 116a is substantially equal in size to the bottom of the cylindrical lens 112. Each of the circular parts 116a has a square opening located in the middle thereof when viewed in a plan view in the direction X, and, one side of the square opening has a length in a range of 3 mm to 5 mm, which is substantially equal to the length L1 of one side of the base support 111b for supporting the LED chip 111a, so that the base support 111b is inserted into this opening.

The first reflecting member 115 comprises a first reflecting portion 1151 having a square outer shape when viewed in a plan view in the direction X, and a second reflecting portion 1152 which surrounds the first reflecting portion 1151 and extends with inclination so as to gradually separate from the printed circuit board 12 with increasing a distance from the LED chip 111a.

The first reflecting portion 1151 is so configured that each side of a square defining its shape as viewed in a plan view in the direction X becomes parallel to the direction of rows or columns of the matrix arrangement of a plurality of LED chips 111a. Moreover, the first reflecting portion 1151 is formed with a groove 1151a surrounding the reflecting sheet 116.

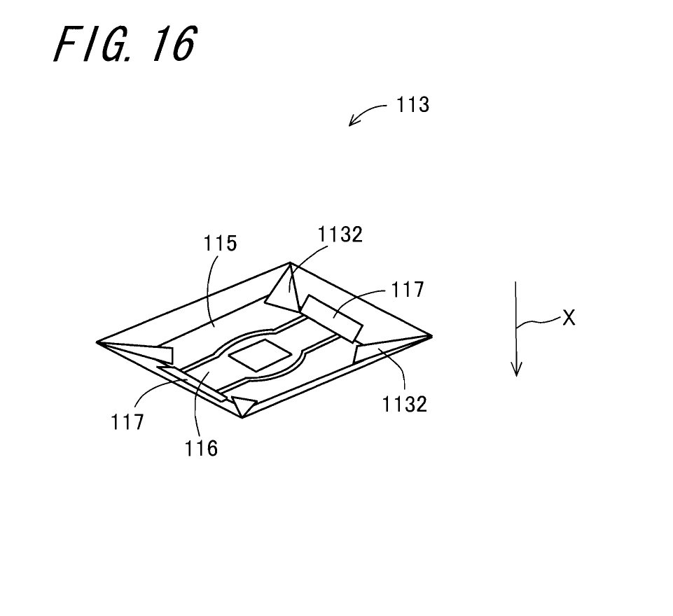

The second reflecting portion 1152 is composed of four trapezoidal flat plates 1152a each having a trapezoidal main surface. In each of the trapezoidal flat plates 1152a, a shorter base 1152aa of the trapezoid merges with each side of the square first reflecting portion 1151, and, a longer base 1152ab thereof lies farther away than the first reflecting portion 1151 with respect to the printed circuit board 12 in the direction X. The adjacent trapezoidal flat plates 1152a are continuous with each other at their legs 1152ac. Two trapezoidal flat plates 1152a merging with two sides, respectively, of the square first reflecting portion 1151 perpendicular to the direction Y are each formed with a concavity 1152ad in which is inserted the strip-like part 116b of the reflecting sheet 116. At the time of forming the concavity 1152ad, however, a gap may be created at the concavity 1152ad, which leads to leakage of light, and therefore, as shown in FIG. 16, a third reflecting member 117 is provided to cover the gap.

In the third embodiment as thus far described, in the direction Y in which the reflecting sheet 116 extends, in a region between the adjacent LED chips 111a, light emitted from the LED chips 111a is restrained from entering and being absorbed by the printed circuit board 12, with consequent improvement in energy efficiency in the backlight unit 1. The backlight unit of the third embodiment can be assembled in the following manner.

As shown in FIG. 15, the first step is to dispose the reflecting sheet 116 extending in the direction Y on the printed circuit board 12, on which a plurality of LED chips 111a each supported by the base support 111b are arranged in the direction Y, so as to surround each of the LED chips 111a. Next, the second step is to cover each of the LED chips 111a by the lens 112 on the reflecting sheet 116. Then, the third step is to dispose the first reflecting member 115 which comprises the first reflecting portion 1151 surrounding the reflecting sheet 116 and the second reflecting portion 1152 surrounding the first reflecting portion 1151, and in addition the second reflecting member 1132 placed on the first reflecting portion 1151. The assembly of the backlight unit of the third embodiment according to the above-described process steps is conducive to more efficient production of backlight units.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and the range of equivalency of the claims are therefore intended to be embraced therein.

### REFERENCE SIGNS LIST

1: Backlight unit
2: Liquid-crystal panel
3: Diffusion plate
11: Light-emitting device
12: Printed circuit board
13: Frame member
100: Liquid-crystal display apparatus
111a: LED chip
111b: Base support
112: Lens
113: Reflective member
114: Light quantity adjustment member
115, 118, 1131: First Reflecting member
116: Reflecting sheet

1. A light-emitting device for applying light to an illumination object, comprising:
a light-emitting portion that emits light; and
a reflective member that reflects light emitted from the light-emitting portion, the reflective member comprising a base portion which is disposed around the light-emitting portion in a position farther away than the light-emitting portion with respect to the illumination object in an optical-axis direction of the light-emitting portion and extends in a flat form in a direction perpendicular to an optical axis of the light-emitting portion, and
an inclined portion surrounding the light-emitting portion to be inclined with respect to the base portion, a surface of the inclined portion facing the light-emitting portion extending in a flat form,
the light-emitting portion being configured to emit light toward at least the base portion, and including a light-emitting element, a base support which supports the light-emitting element, and an optical member which is disposed so as to cover the light-emitting element and refract light emitted from the light-emitting element in a plurality of directions,
the reflective member being so disposed that light emitted from a side surface of the optical member is reflected from the base portion, part of the light reflected from the base portion is applied to the illumination object, and another part of the light reflected from the base portion is further reflected from the inclined portion so as to be applied to the illumination object.

2. The light-emitting device according to claim 1,
wherein the optical member is disposed in contact with the base support.

3. The light-emitting device according to claim 1,
wherein an area of the base portion projected on the illumination object is greater than an area of the inclined portion projected on the illumination object.

4. The light-emitting device according to claim 1,
wherein a distance in the optical-axis direction between a part of the inclined portion which lies farthest from a surface of the base portion in the optical-axis direction and the surface of the base portion is shorter than a distance in the optical-axis direction between a part of the optical member which lies farthest from the surface of the base portion in the optical-axis direction and the surface of the base portion.

5. An illuminating apparatus comprising:
a plurality of the light-emitting devices according to claim 1, the plurality of the light-emitting devices being arranged in an orderly manner.

6. The illuminating apparatus according to claim 5,
wherein a plurality of the reflective members provided in the light-emitting devices are integrally formed at inclined portions thereof so that the reflective members are continuous with respective adjacent ones.

7. A display apparatus comprising:
a display panel; and
an illuminating apparatus including the light-emitting device according to claim 1, the illuminating apparatus applying light to a back side of the display panel.

8. A display apparatus comprising:
a display panel; and
an illuminating apparatus including the illuminating apparatus according to claim 5, the illuminating apparatus applying light to a back side of the display panel.
